(19) United States
(12) Patent Application Publication
(10) Pub. No.: US 2002/0147623 A1
(43) Pub. Date: Oct. 10, 2002

(54) Method for interactive communication and information processing

(76) Inventor: Ismail Ibrahim Rifaat, Doha (QA)

Correspondence Address: Shafik I. Rifaat, 2402 Commonwealth Avenue, Houston, TX, 77006, US

(21) Appl. No.: 10/090,478

(22) Filed: Mar. 4, 2002

Related U.S. Application Data
(60) Provisional application No. 60/273,205, filed on Mar. 2, 2001.

(51) Int. Cl. G06F 17/60

(52) U.S. Cl. 705/7

(57) ABSTRACT

A method for interactive communication comprises the steps of: gathering information about a topic; analyzing the information to identify existing and potential issues; selecting ones of the issues in accordance with selection criteria to form a set of selected issues; formulating goals in respect of the selected issues; preparing alternative scenarios for resolving the selected issues for meeting the goals; evaluating the alternative scenarios; and selecting at least one of the scenarios for meeting the goals.

Reference is hereby made to copending Provisional Patent Application No. 60/273,205 filed Mar. 2, 2001 in the name of the present inventor, Ismail I. Rifaat, entitled APPARATUS AND METHOD FOR INTERACTIVE COMMUNICATION AND INFORMATION PROCESSING, whereof the disclosure is hereby incorporated by reference in the present application and whereof the benefit is claimed.

The present invention relates generally to interactive polling and, more particularly, to applications thereof whereby an influence is brought to bear on future developments and events, so as to shape the future in a more systematic manner with public participation in the definition of problems, goals, and solutions.

Present methods of planning and influencing the flow of future events and conditions tend to be unsystematic and based on premises which are not always clearly understood nor consistently applied. Questions and problems are recognized frequently only on an ad hoc basis that may also be haphazard. Moreover, many who are affected by the outcome of such planning are often not involved in the process or, at best, enter into the process only in an indirect and ofter accidental manner that does not sufficiently take account of their views.

In accordance with an aspect of the invention, a method for influencing development in a given topic, comprising the steps of: gathering information about the topic; analyzing the information to identify existing and potential issues; selecting ones of the issues in accordance with selection criteria to form a set of selected issues; formulating goals in respect of the selected issues; preparing alternative scenarios for resolving the selected issues for meeting the goals; evaluating the alternative scenarios; and selecting at least one of the scenarios for meeting the goals.

It is herein recognized that each person contributes to shaping the future through their action. People do this with varying degrees of awareness of the potential impact of their deeds, and often without ‘willful’ planning and ‘purpose’. Science and philosophy could be considered to have ‘contributed to shaping the future of humanity’ although they may not have been ‘intentionally pursued towards this end’. It may be added that many ‘organized’ and ‘willful’ efforts to shape the future have been, and continue to be undertaken. History provides an account of past efforts. What environmentalists and those involved in space exploration do, are contemporary examples of such efforts. In recent years, efforts relating to environmental protection, and to space exploration have picked up pace. Movies depicting the perils to our existence have been made. Accordingly, the ‘awareness of issues’, and the attempts to plan for the future in organized ways are underway, and are receiving ever more attention and dedicated effort. In introducing tychiformation, or “forming the future”, which term will be explained further in the detailed description of the present invention, it is herein proposed that the augmentation of these efforts proceed in a ‘more organized fashion’. In particular, it is contemplated that efforts to guide and control the future of humanity be pursued by:

1. Identification of ‘critical issues’, and addressing ‘topmost priorities’ in strategic fashion;

2. Adopting a systematic planning approach that explicitly articulates a ‘reasoned process’ that covers the ‘widest possible context in space, time, and content, and which allows synthesis of considerations from as many different parameters as practicable’; and

3. Involving ‘the largest number of individuals directly in addressing tasks 1, and 2 above within practicable limits’.

From his perspective, the present inventor would tentatively ‘prioritize issues’ for a strategic approach to tychiformation in descending order starting with ‘issues’ relating to survival, followed by ‘issues’ relating to ‘morality’, leading to consideration of ‘issues’ relating to ‘quality of life’. However, these categories of ‘issues’, and/or subcategories of these ‘issues’ can be pursued in parallel, or in different order according to people's ‘wishes’.

An important topic is how the Internet has, and will continue to change the way we go about our lives. It has already impacted the ways we seek information, and the ways we acquire goods for example. Internet sites also provide information about legislative ‘issues’. Some sites provide information about how politicians vote, and invite the public to register their vote in respect of the issues under consideration. Such efforts may be viewed as attempts to use the Internet while following prevailing traditions. Tychiformation on the other hand, would take fuller advantage of Internet capabilities by involving the general public in the ‘identification, and prioritization of issues’ to be addressed in the first place, and further, in all consequent steps to reach decisions for action.

Some may think that the universe, and the human predicament in particular, reflect chaotic conditions that would ‘defy’ tychiformation. It is herein recognized that tychiformation would not ‘solve all the problems of the world’. However, it is proposed that tychiformation be introduced for the benefits that may be secured thereby. A novel aspect of the present invention relates to the extent of expansion of the planning context in space, time, subject matter, number of people involved, and number of steps where public participation would be sought in tychiformation. Containment of the efforts expended towards planning within ‘practicable’ limits; the containment of effort requiring prioritization of the issues to be addressed, and the adoption of a strategic approach in tychiformation are contemplated. Thus, it is contemplated optionally to remove customary limits or boundaries to the application of systematic planning, within ‘practicable’ limits. An aspect of the invention is the option of applying a planning methodology in accordance with the invention in addressing moral issues.

An option contemplated for the initiation of tychiformation is through ‘floating’ of the ideas incorporated in the present description—as in a trial balloon. The next step or steps would depend on the public's response. The amount and variety of responses would help in the definition of succeeding steps. An optional step as one of the first steps to follow a ‘positive’ response is to pursue the definition of ‘the rules of the game’ for proceeding with tychiformation. If a majority of respondents raise a particular ‘issue’, then the particular ‘issue’ of concern to the majority can be presented for debate first.

On the other hand, if the floating of the balloon—an invitation to others to participate in tychiformation—leads to a flood of responses, perhaps in the form of ‘hits’ of an Internet site, this can present opportunities of commercial value.

Aspects of the present invention herein considered include:

1. Relativism

An original and consistent expression of a relativistic philosophical position is presented in a way which indicates the adoption of relativism as the result of personal preference, rather than as a ‘logical’ or ‘rational’ conclusion.

2. Action/Planning

Action, and planning for action are considered within an evolutionary relativistic framework as instinctive/intuitive activities.

3. Tychiformation

As explained, this is a term coined by the present inventor in connection with the present invention which incorporates proposals for action to shape the future of humanity within a relativistic framework. Tychiformation envisages shaping the future of humanity through the application of a systematic strategic planning process that predicates the participation of the general public in interactive fashion, for example, through the electronic media.

In reference to neural networks and learning, it is herein recognized that the human brain, and perhaps the cerebral cortex of the brain, can be considered as sites where neural inputs are synthesized or integrated. It is herein recognized that a Tychiformation Center could be considered as providing a site for the integration of inputs from individual human minds. It can perform a function analogous to that of the brain or the cortex, albeit the inputs to be integrated would come from whole minds as opposed to nerves or neurons. In accordance with an aspect of the present invention, it is contemplated to provide such a center or centers for synthesis and integration of peoples' inputs, whether it involves tychiformation or not. Furthermore, the integration of inputs may be carried out through an ascending hierarchy of centers. The relationship with tychiformation however might ‘carry some weight’, since a Tychiformation Center is intended to perform similar functions to the brain and the cortex; such as securing existence. The brain integrates neural inputs resulting in the action of the individual to secure his survival and well being, while a Tychiformation Center would integrate inputs from individual humans towards the definition of action to secure the survival and well being of the human species.

In many fields of human activity and/or interest, a need may be found to arrive at a decision. By way of example, consider the fields of architecture and planning.

The type of project, whether it is for a house, a school, or a hospital impacts the complexity of activities and effort required to complete the project. Such projects may cover a whole range of complexity. Larger projects of the same type are usually more complex and require more effort to complete. In residential design, preparing a design scheme for a mansion usually requires more effort, compared with the design of a modest house. The scope of work, whether it covers the preparation of construction documents only, or whether it includes also supervision of construction, impacts the magnitude of the effort required. The number of individuals on the client's side also influences the degree of complexity, and the effort involved in professional assignments. Generally, the complexity relating to the nature of the client starts from the case where the building is for one client. The complexity usually increases as the number of individuals increases on the client's side, as in the case of designing a residence for a family where the husband and wife, and possibly their adult children have different and conflicting expectations. Then comes the case of a client represented by committee, where several members may hold varied and opposing positions. The higher degrees of complexity in this context relate to urban planning assignments where several committees and agencies may be involved, and further, where a total population with conflicting interests may be viewed as the ultimate client.

The increase of complexity in professional assignments which influences the types of activities, and the extent of effort that would be required to complete each particular project are usually reflected in contracts for the provision of professional services. In the relatively simple architectural assignment of designing a residence, a typical contract would refer to the intended size and the program of uses which covers living areas, number of bedrooms, and so on. The typical contract usually indicates the progression of the professional activities to be undertaken. These are usually: schematic design, preliminary design, preparation of construction documents, and construction site visitation, or construction supervision as required. Contracts for larger architectural projects are more elaborate. They may include: the preparation of detailed specifications describing all the elements that will be incorporated in constructing the building, bills of quantities of all materials that will be used in construction, tender documents to solicit bids from construction contractors, critical path schedules describing the sequence of construction, and possibly more tasks commensurate with the importance of the project.

The tasks involved in urban planning work are in many ways similar to the tasks involved in relatively ‘simple’ architectural assignments. However, they tend to be more elaborate. For example, the act of acquainting oneself with a single client in the case of a ‘small’ building project expands to numerous activities to gather information about socioeconomic and demographic characteristics of a given population in the case of an urban planning assignment. The task of gathering information about the site of the project, a relatively ‘simple’ task in the case of a plot of land for a house, grows to gathering information about conditions in an entire city in the case of city planning. Further complexity relates to the dynamic changes of conditions in a city over time, compared with the changes of conditions relating to a building plot and a single client. The extent of complexity in urban planning also impacts the types of output that are expected from various assignments. In architectural assignments, the final output is usually a physical building. Urban planning studies on the other hand often only reach the stage of formulating general strategies and policies for action.

Such increases in complexity are reflected in the contracts for providing professional services in urban planning, which dwell on possibly elaborate explanations of the tasks to be performed, the methodologies to be pursued, and the definition of the outputs to be realized from urban planning studies. In particular, methodologies that may be briefly expressed, or implicitly recognized but not at all articulated in a contract to design a building, are usually articulated in detail in contracts for urban planning studies.

The activities involved at the opposite ends of the spectrum of complexity are usually different in numerous ways, and are often carried out by different types of ‘experts’, to the point that the similarities among different assignments alluded to above get ‘blurred’ beyond easy recognition. For example, the act of ‘design’ which may be considered to be ‘largely intuitive’, and which may be involved in some measure throughout the spectrum of the different types of assignments that occur, is rarely mentioned in conjunction with large scale urban planning studies. On the other hand, the process of ‘planning’ which is considered to be ‘rational’, and which may be regarded also as involved in the full spectrum of assignments, is rarely explicitly referred to in respect of small building projects. In the case of designing a house, the planning process to be pursued is usually implicitly recognized and followed, but is rarely expressed. Reference to planning in architectural design contracts may only appear in phrases regarding the “preparation of plans”, without describing how plans are to be prepared. The planning process to be pursued in urban planning is however almost always explicitly articulated and expressed in detail in the case of large scale urban planning studies.

Thus, there are differences between assignments that relate to complexity, and to the different ‘nature’ of a client. In particular, devising a scheme for action in architecture may involve the integration of the ‘values’ of only two individuals, an architect and his client; or possibly three individuals, to include the building official whose ‘values’ have to be integrated in order to obtain ‘approval’ of the project. Urban planning on the other hand involves more people, and a quantum increase in the different ‘value judgements’ to be integrated in preparing a scheme for action. This leads to increasing the difficulty of developing consensus. Such difficulty is generally reflected in experience: typically greater degrees of agreement and satisfaction is reached with clients on architectural assignments, compared with urban planning assignments.

However, experience in urban planning in recent years has heightened awareness of relativistic ‘issues’. Accordingly, in the following discussion, by way of example, the focus will be on the types of activities commonly referred to as ‘planning’ activities. They are applicable in the case of designing a house, and in planning a city. While the present example is in terms of this field, the activities are also involved in, for example, planning a vacation, and planning for national defense. In order to maintain the focus of the discussion, the use of the present example will be continued, it being understood that it is not in any way intended to be limiting but rather illustrative of the broader principles to which the present invention relates.

By way of clarifying the present description, the following is intended to generally familiarize the reader with the field of urban planning, and to highlight certain activities in the field that pertain to an example of the application of the present invention. The text is not intended as a technical essay on urban planning. The interested reader is referred to textbooks, such as “Introduction to Urban Planning” for a more comprehensive exposition of the field (Anthony J. Catanese, James C. Snyder, McGraw-Hill, Inc., 1979) for additional details. Quoting from this book, under the main title “Planning Theory”, and the subtitle “What is Planning?” the statement is made (page 108):

“We defined theory in terms that could apply to any field of professional practice. An account of planning theory must therefore, relate it specifically to planning and will subsume the question, “What is Planning?”. Nearly 20 years ago John Dyckman referred to the discussion of this last question as “a literature of controversy”; recently, Henry Hightower said, “the ‘square one’ question is: ‘what is planning’”. Clearly, not much has changed. Over the years, however, many attempts have been made to find an answer. The various definitions of planning proposed cover a wide range but do not indicate a consensus.”

The book proceeds to review a number of alternative definitions of “planning” that are considered to be “not necessarily mutually exclusive”.

Generally, the present inventor considers urban planning as an effort to accommodate people to live in a physical environment. Now, the overall population of the world has been constantly growing. In parallel however, the population of certain areas has been declining. The migration of rural populations to urban centers is one example reflecting this condition. In both cases of declining and growing population, the urban planner is called upon to anticipate future conditions, and to plan for future urban development. Reference is herein generally made to the more common example of planning to accommodate population growth.

Accommodating population growth may be achieved by expansion of existing urban areas, or by creating new human settlements such as new towns and cities. For the purposes of discussion, the more common case of planning for the growth of existing urban areas will be presented, it being understood that no limitation is thereby intended.

The activities of urban planning vary depending on the nature of the urban planning assignment. Following is a brief description of the typical activities involved in the common case of planning for the potential future expansion of an existing urban area.

Data Collection, organization, and storage are activities that are typically undertaken to document existing and past conditions regarding any urban area intended for study. The information gathered generally relates to people and to the environment. Information regarding people includes demographic and socioeconomic characteristics. Information regarding the environment covers various facets and conditions of the natural and built environment. Information is gathered and updated by various methods such as by record keeping of changes in conditions when they occur, as in the case of births and deaths, or through field surveys, for example, to identify ‘derelict’ building conditions. Information is usually organized and stored electronically, often in elaborate systems referred to as Geographic Information Systems. They facilitate the retrieval and use of available information. In addition, information regarding the institutions and regulations that impact urban planning are compiled for each particular area intended for study.

There follows a discussion of Analysis/Assesment of Conditions, Identification of Trends, Existing and Future Requirements, and ‘Issues’. Analysis or ‘assessment’ is undertaken in ‘quantitative’ or ‘qualitative’ fashion. ‘Quantitative assessment’ applies to certain parameters that can be represented by numbers, such as for example those relating to the number of the population, and to the movement of vehicles. ‘Qualitative assessment’ applies to parameters such as visual ‘quality’. The analysis of gathered information including the changes in conditions over time, leads to the identification of trends. For example, consecutive census counts, and information regarding fertility rates of an indigenous population, births and deaths, in and out migration, and other historical data are analyzed to identify past trends in changes to the population number and characteristics. Other trends may relate to residential land uses, and to the changes in the prevalence of various types of dwelling units by spatial location. Various methods are then used to extrapolate or project historical trends into the future, in an attempt to estimate the future population of the area under consideration, and to quantify various ‘needs’ that will be required to sustain the population in the future. Computer modeling is often used for these purposes. In particular, modeling is often used to anticipate changes relating to population numbers and to traffic movement.

The ‘assessment’ of existing and historical conditions also leads to the identification of past and present ‘problems’; more often referred to in urban planning as ‘issues’. ‘Issues’ may relate to ‘shortages’ in housing, to traffic ‘congestion’, or to ‘deficits’ in the provision of community facilities such as schools and clinics. The projection of trends can indicate whether existing ‘problems’ will ‘improve’, or be further ‘aggravated’ in the future. Projection can also indicate the potential for new ‘issues’ to arise, if the identified trends continue to prevail. It might be added in this context that an urban area can be considered as a living organism, and that the early activities of urban planning are concerned with the ‘diagnosis’ of conditions, the identification of existing ‘problems’, and the quantification of future ‘needs’ in the area designated for study.

With regard to the formulation of ‘goals’ and ‘Objectionves’, the definition of ‘goals’ generally involves the contemplation of a ‘vision’ that envisages the ‘rectification’ of ‘undesirable’ conditions, and the promotion of ‘desirable’ ones. ‘Goals’ and ‘objectives’ usually address the ‘issues’, and the ‘needs’ that have been identified. For example, if one of the ‘issues’ identified relates to a ‘shortage’ of ‘affordable’ housing to ‘low income’ groups of the population, the corresponding goal might state: “Provide ‘adequate’ ‘affordable’ housing to ‘low income’ groups in the city”. Objectives relate in turn to expressed goals, but are further articulated and often quantified. An objective could state: “Provide 1000 ‘affordable’ housing units in the inner city by the year 2010”.

Regarding the identification of ‘opportunities’ and ‘constraints’, continuing with the example of ‘affordable’ housing, an ‘opportunity’ might relate to the existence of ‘relatively inexpensive’ vacant land in the inner city that is ‘suitable’ to accommodate the required number of ‘affordable’ housing units. A ‘constraint’ in the same context could relate to the lack of such ‘inexpensive’ vacant land in the inner city.

There follows a discussion of Synthesis/Integration, Preparation of Alternative Scenarios and Schemes for Action. The preparation of scenarios for action is concerned with finding possible ‘remedies’ and ‘solutions’ to ‘resolve’ identified ‘problems’, and to meet anticipated ‘needs’ for urban development. The activities involve ‘synthesis’ of elements from previous analysis, including identified ‘issues’, ‘needs’, ‘opportunities’ and ‘constraints’, and stated ‘goals’ and ‘objectives’.

It should be noted in this context that, generally, no amount of analysis could lead by itself to conceiving a solution. The activities involved in synthesis, it is herein recognized, are akin to those involved in an ‘intuitive’ act of ‘design’, and probably involve some variety of ‘fuzzy logic’. Furthermore, while different parameters may be analyzed by different specialists in an urban planning team, overall synthesis typically takes place in one mind; often the team leader's mind. Usually a number of alternative ‘solutions’ are conceived. The number of alternatives is often limited to three different options. The potential ‘solutions’ can vary in nature, and level of detail. Alternative ‘solutions’ may be conceived at the level of strategies and policies to address the ‘issues’ and the ‘needs’ that have been identified, such as in the case when alternative strategies are conceived to revitalize the development of a ‘deteriorating’ inner city. The alternative strategies and associated policies could be conceived in the form of statements that may propose, for example, ‘improving’ public transportation, and reducing property and sales taxes in the targeted area. Alternative solutions may be conceived otherwise in the form of urban development or redevelopment schemes. The alternative schemes may be in the form of urban design projects for example, to provide housing, roads, infrastructure, community facilities, and pedestrian paths and landscaping in an area of study.

There follows a discussion of the ‘Evaluation’ of Alternatives and the Selection of a ‘Preferred’ Alternative. The activities involved in this stage of urban planning are concerned with the ‘evaluation’ of the various types of alternative ‘solutions’ against stated ‘goals’ and ‘objectives’. Matrices are often prepared to ‘gauge’ the extent to which each alternative ‘solution’ would ‘meet’ each of the ‘goals’ and ‘objectives’ that has been previously ‘agreed to’. The alternative scenario or scheme that is considered to ‘meet’ ‘goals and ‘objectives’ ‘most closely’ is ‘selected’ and proposed for adoption and implementation.

Next, we consider Preparation for Implementation. The proposals and recommendations that result from planning studies involve various types and categories of potential action. Generally, the urban planner's activities in respect of implementation are concerned with attempts to bring the results of study to materialization. Implementation may involve the preparation and adoption of codes and regulations, or securing budgets for further detailed study, or for actual construction. The steps involved in implementation, and the phasing of development are usually indicated.

It is herein recognized that the Urban Planning process may be considered as continuous and iterative. Since conditions constantly change, urban planners typically constantly strive to update their databases, and periodically repeat the types of activities involved in urban planning that have been mentioned. The iterative nature of urban planning activities can be discerned in the case where the activities involved in preparing alternative ‘solutions’ ‘reveals’ the ‘impracticability’ of achieving stated ‘goals’ and ‘objectives’. In such a case ‘goals’ and ‘objectives’ would be reformulated, and previously undertaken work may be repeated. Another example that illustrates the iterative nature of planning relates to the transportation element in urban planning. New roads and highways are often constructed to ‘alleviate’ traffic ‘congestion’. Invariably however, new roads and highways attract progressively ‘more’ traffic. Vehicular traffic ‘spurs’ new urban development that in turn increases traffic, and the cycle continues leading to traffic ‘congestion’ of the newly constructed road. This usually leads to the reiteration of the planning process. Furthermore, the initiation and reiteration of the activities involved in urban planning may not necessarily occur in the sequence indicated above. Urban planning studies may be initiated through recognition of a ‘problem’, as for example, when a segment of the population complains about a ‘shortage’of health facilities in their area. The collection of ‘pertinent’ information by the urban planner in this case may follow, rather than precede the activities of the identification of the problem. The urban planning process may be initiated also through expression of a ‘goal’. A ‘political goal’ could be expressed to ‘improve conditions in the inner city’. The steps of gathering information and the identification of ‘problems’ or ‘issues’ involved in meeting the stated ‘goal’ would follow. In some cases urban planning could be initiated through ‘identification of an opportunity’, as in the case when a developer identifies ‘inexpensive’ land that could be developed for ‘profit’.

Next the spatial context of urban planning, the hierarchy of planning studies, the the Top Down and Bottom Up approaches will be discussed. Urban planning can be addressed at different spatial levels. The levels of study are usually classified in ‘hierarchical order’. In descending order of extent of spatial coverage and generality, the hierarchy of urban planning studies is usually classified into national, regional, city, town, village, district, and local area levels. Approaching planning studies sequentially in such an order is referred to as a top down approach. On the other hand, considering a local area with a view of discovering the potential impact of local conditions on considerations at higher levels of study is referred to as a bottom up approach. Generally, the hierarchy of studies involves progressively more attention to detail in descending order, starting from the more general at the national level, to the most specific at the local area level. The Time Frame for Urban Planning/‘Short’, ‘Medium’, and ‘Long’ Term Planning The time frame designated for urban planning studies can vary. Prevailing convention defines ‘short’ term planning for periods between one to five years, ‘medium’ term, from five to ten years, and ‘long’ term, from ten to twenty years commonly used period in city planning is twenty years from the time of starting a study, such as from the year 2000, to the year 2020. The year 2020 would be referred to as the planning horizon. The urban planner is expected to anticipate changes in conditions, and to address ‘issues’ and ‘needs’ within the planning period up to the designated planning horizon.

The parameters addressed in urban planning are usually classified into two main categories relating to people, and to the environment. The parameters relating to people are grouped under “socioeconomic conditions”. These include subcategories relating to population demographic, social, and economic characteristics and conditions, and cover topics such as population fertility, natural growth rates, age cohorts, family composition, employment, income levels, spending patterns, and so on. The category of parameters relating to environmental conditions, covers natural and man made resources. It covers surface, subsurface, and air quality conditions, as well as building conditions, land use, land values, land ownership, all modes of transportation, and utilities infrastructure. The parameter relating to land use is subdivided into the subcategories of residential, commercial, industrial, public and community facilities, and vacant land. The residential and commercial subcategories are classified further into different types and densities, and so on.

Consideration of ‘Wider’ Context in urban planning will next be considered. Each particular assignment in urban planning is addressed in what is commonly referred technically as “wider context”. The term commonly refers to ‘wider’ spatial context, but can be understood also to involve expansion of the time, and parameters covered by study.

Areas designated for urban planning studies are usually considered in ‘wider’ spatial context. For example, a national urban planning study usually takes into consideration international conditions, since the latter invariably impact considerations at the national level. In similar fashion the study of a region is usually addressed in the national context, and the study of a city is usually addressed in the context of the region where the city is located, and so on. The study of a local area may involve the consideration of conditions in the district, or the entire city in which the local area is located.

Expansion of the span of time covered by a study is next considered. The collection of historical data, and their analysis, can be extended backward to cover past conditions starting from the time of initial inceptions of human settlement in the area of study, or even to earlier pristine conditions. This usually provides ‘insights’ that could be ‘used’ in conceiving schemes for future development. Also, the planning horizon may be extended forward in time beyond 20 years. Although prediction tends to be ‘more tenuous’ for ‘longer’ periods of time in the future, the exercise of projecting prevailing trends can be used to ‘highlight’ potential ‘problems’. For example one could project population growth for the next 50 years at a certain prevailing rate, although the rate is not expected to continue that long. This is often done in order to illustrate the potential ‘adverse’ conditions that might materialize if the particular rate of growth continued.

Considering next increasing the number of parameters covered by study: generally, the urban planner can ‘assess’ and make use of almost any type of information that is available about people, and the environment. For example information regarding the rate of incidence of crime, car and pedestrian accidents, and health conditions, which may be thought of as not of the urban planner's business, are often ‘assessed’ by planners to identify ‘deficiencies’ in the urban and social fabric of a city. The extent of the parameters that could be covered in urban planning may be considered ‘open-ended’.

By way of examples of different approaches to urban planning, following are some of the main types of approach to urban planning. Urban planners typically attempt to apply the planning process in addressing ‘issues’ irrespective of the type of approach they elect to pursue.

Reactive and proactive planning are possible. The classification into these two types of approach relates to the urban planner's general attitude in addressing ‘issues’. The reactive mode could be understood as exemplifying an attitude to cope with ‘issues’ as they occur. This may be thought of as a type of spontaneous problem solving rather than ‘planning’. Another way of interpreting the term “reactive planning” implies the acceptance of particular identified conditions and trends, and assuming that they will prevail in the future. In this sense, the urban planner assumes a reactive attitude towards conditions and trends that he ‘feels’ that he does not wish to change, cannot change, or ‘has no business’ in changing. The reactive attitude is reflected often in the planner's acceptance of population socioeconomic conditions and trends, as for example, the rate of growth of a particular population.

The proactive mode embodies an attitude to interfere with, and to change conditions and trends. The urban planner assumes a proactive attitude when he thinks that certain conditions or trends ‘need to be changed in order to meet stated goals and objectives’. A mixture of both attitudes prevails in practice, and applies in all the following types of approaches to urban planning.

Prevention, Visionary, and Crisis Planning are considered next. One can consider “crisis planning” to be synonymous with “reactive planning”, in the sense that it means coping with events and ‘problems’ as they occur. Accordingly, ‘crisis planning’ may be thought of as a form of problem solving rather than as a form of ‘planning’. Prevention and visionary planning respectively attempt to avoid ‘negative’ conditions, and to attain ‘positive’ conditions in the future. Typically, entities entrusted with planning appear to be involved more with putting out fires, i.e. spontaneous problem solving, rather than with prevention or visionary planning.

Comprehensive economic and urban development planning are next discussed. Changes in the economy affect urban development, and the rate of growth or decline in economic development usually leads to parallel changes in urban development. The urban planner can assume a reactive attitude in this respect by accepting the economic forecasts prepared by economists, and by addressing the likely impacts on urban development. Alternatively, the urban planner can join forces with the economic planner, and jointly address both economic and urban planning development. This leads to the integration of their respective inputs, and allows the ‘concerns’ of the urban planner to influence the economic planner, and vice versa. Ministries of planning are established in many countries to approach planning in this fashion.

Comprehensive physical urban planning is next discussed. Economic planning and urban planning are often undertaken by different independent entities. “Comprehensive urban planning” refers to the case where the urban planner takes economic development into consideration, but carries his work independently from the economic planner. The approach is sometimes termed “comprehensive physical planning” to indicate that the study does not cover economic planning in proactive fashion. The word “comprehensive” in this approach may be understood to indicate that ‘all’ parameters involved in urban planning would be addressed. The approach is sometimes also understood as indicating a top down approach, envisaging the completion of the hierarchy of planning studies starting from the national level, and proceeding through lower levels of studies all the way down to the detailed planning of local areas.

The term “strategic planning” is some times used to indicate the planner's intent to stop his work at the level of conceiving general strategies for action, without getting to the level of conceiving particular ‘solutions’ and schemes for physical implementation. In another sense, the term refers to the planner's intent to limit his work to addressing ‘critical’ issues only, sometimes perhaps even in ‘detail’. This involves ‘ranking’ identified ‘issues’, and assigning ‘priority’ to addressing the ‘most critical’ among them. A third possible meaning relates to the planner's intent to match his work to ‘available resources’. The second and third definitions are ‘closely’ related to each other. The latter two definitions may be considered as demonstrating a ‘central issue’ to urban planning, and to the concept of planning in general.

Urban planning consulting assignments come in ‘packets’ to be performed within specified ‘constraints’ of time and fees. They often involve areas of hundreds, and sometimes thousands of square kilometers. The ‘problem’ arises in urban planning as to how much ‘terrain’, spatial and otherwise, could be covered within the period of between one and three years that is commonly specified for urban planning studies. By ‘necessity’, only a limited quantum of ‘issues’ can be addressed and ‘resolved’. The preference to address ‘important’ rather than ‘trivial issues’, ‘predicates’ the consideration of ‘criticality’ and ‘prioritization’, i.e. ‘strategizing’. These considerations apply to all sorts of planning. The relatively ‘larger’ spatial expanse involved in urban planning only ‘highlights’ the ‘issue’. All types of planning activities are undertaken within some form of ‘constraint’ or another, which ‘predicates’ ‘strategizing’. From this perspective therefore, all types of planning could be considered as strategic.

The development of consensus and public participation is next considered. Urban planning as practiced today, is a relatively modem phenomenon. Historically, urban planning efforts usually involved a potentate and an architect, in a way similar to that of an individual commissioning an architect to design a building. The potentate assumed the decision making role as a single ‘client’, and the architect tended to address limited physical 'design’ parameters in ‘largely intuitive’ fashion. The general public was rarely involved in the process of urban planning. Potentates in some developing countries, and some major developers still approach urban planning in similar fashion, albeit more parameters are now being taken into consideration in the preparation of schemes for urban development than in the past. Contemporary practice however, commonly involves government entities, and numerous individuals on the decision making side of the ‘client’. Although the general public is often not directly involved in the process of planning, reaching agreement regarding action in contemporary practice involves the development of ‘consensus’ among numerous ‘players’.

Recent developments in the field however, indicate a trend to involve the people affected by planning, in the planning process. One of the ‘buzz words’ in the field of urban planning in recent years is “public participation”. This trend is reflected in certain urban planning efforts, in particular in urban redevelopment projects that affect the lives of a resident population. Planners ‘set up shop’ in the area targeted for study. From their location within the community, the planners strive to interact with the local residents, seek their participation in the planning process, and engage the residents in the ‘assessment’ of conditions, and in developing consensus for potential action. The ‘reason’ for this recent trend may possibly be that more urban planners are tending to become ‘relativist’.

Relativism and the ‘rationality’ of the planning process are next discussed. Urban planning, like architecture, is a field of endeavor that is ‘geared’ to action. As herein defined, steps involved in the planning process are driven by individual momentary ‘subjective value judgement’. The use of single quotes in the present text helps illustrate the ‘extent of prevalence of subjective and potentially variable valuation’ in the urban planning process. “The ‘assessment’ of existing conditions”, “the identification of ‘issues’”, “the ‘prioritization’ of ‘issues’”, “the ‘evaluation’ and ‘ranking’ of alternatives and the ‘selection’ of a ‘preferred’ alternative”, are all phrases describing main steps in the planning process. Each phrase includes one or more words that may be considered to reflect the involvement of ‘subjective and potentially variable valuation’. A few examples follow to illustrate the foregoing.

For example, the ‘assessment’ of existing conditions in a large metropolis some times ‘reveals’ the presence of squatter shacks, slums, or a shantytown near the center of the city. This could be referred to in urban planning jargon as ‘having identified issues relating to the existence of substandard housing, and the presence of negative visual conditions in the heart of the city’. Quite often however, the residents of the shantytown do not consider their living there to constitute an ‘issue’ for them. In spite of that, traditionally, the ‘preferred’ urban planning ‘solution’ under such circumstances was to raze the shantytown to the ground and to replace it with other uses ‘commensurate with the prime location of the site’. The residents of the shantytown would be relocated to ‘adequate affordable housing’ to be erected on ‘inexpensive land’, usually in a ‘remote’ location. The first part of the ‘solution’ was usually accomplished, i.e., the shantytown was usually demolished, while the provision of ‘affordable’ housing frequently did not materialize. Even in the rare cases where alternative housing was provided to squatters, the residents of shantytowns quite often did not consider such arrangements as representing a ‘preferred solution’. These considerations illustrate one historical example of different ‘value judgements’ among squatters and urban planners. In recent years, even urban planners themselves have changed their ‘views’ in this context. Most urban planners no longer consider the existence of a shantytown as necessarily reflecting an ‘issue’, but rather as reflecting an ‘economic reality’. They limit the extent of their involvement to attempts to ‘improve’ social and sanitary conditions for squatters.

The ‘identification’ of ‘opportunities’ and ‘constraints’ is an activity that also illustrates the involvement of ‘subjective valuation’ in the planning process. For example, the existence of a shantytown in the inner city may be considered by some as providing an ‘opportunity for redevelopment’. Others who harbor ‘concerns’ regarding the relocation of squatters may consider the existence of the shantytown as a ‘constraint to redevelopment’. A number of planners have hesitated about the consideration of ‘opportunities’ and ‘constraints’ as they ponder how they ‘appear’ from different perspectives.

Another example of the incidence of ‘subjective variable valuation’ can be discerned in the use of ‘valuation matrices’, which by the way are often referred to as “subjective valuation matrices”. The reader is reminded of the general ‘problem’ that discussed earlier regarding the assignment of ‘relative ranking weights’ to the different parameters under ‘evaluation’. For example, grade-separated junctions are often contemplated to ‘improve the flow of traffic’. However, such junctions are often considered by some to have ‘negative visual impact’. The question arises as to ‘how much relative weight could be accorded respectively to the visual and to the transportation parameters’. This ‘problem’ can be encountered also in assigning ‘relative values’ to the ‘pains associated with relocating a resident population’ versus the ‘economic benefits to be derived from urban redevelopment’.

Assigning ‘priority’ is another activity in urban planning that people are likely to disagree about. They usually differ in ‘assessment’ of what is ‘important’, ‘more important’, and ‘most important’. Other examples, not herein enumerated, exist.

Now, by most urban planners' account, urban planning employs the ‘planning process’ that is considered to be ‘rational’. A definition of ‘rationality’ involves the articulation of one's ‘reasons’ for action. Under the notion of the ‘regress of reasons’, people can proceed ‘rationally’ only if and when they have found ‘common grounds’. What then could be the ‘role’ of ‘rationality’ in urban planning, a field where one can expect disagreement to prevail? “Introduction to Urban Planning”, the book quoted above, provides a possible answer. It states (p 111):

“The use of rationality is not intrinsically related to either success or failure; i.e., there is no guarantee that choices arrived at rationally will be good choices. In fact, many if not most such choices would be the same if they had been arrived at intuitively. The axioms of rationality simply insure internal logical consistency, and rational analysis provides a framework to display the decision maker's values and assessments.”

The foregoing provides an outline of urban planning, and indicated the types of activities and the kinds of considerations that are involved in the field. The reader can conceive how the types of activities and the related considerations herein mentioned could apply to all sorts of planning activities. When one plans a vacation one may obtain brochures about different areas that one could visit, flip through the brochures, and decide where one will spend a vacation. One would have gone through the steps of ‘data collection, analysis, identification of opportunities and constraints, etc.’ without necessarily being consciously aware of each of these steps. One may not explicitly express one's ‘goals and objectives in having a good time on vacation’, but one's mind would have intuitively covered this aspect in a process of ‘evaluation’ and ‘selection’. The difference between urban planning and the planning of every day activities is that urban planning explicitly expresses processes that otherwise may be intuitively carried out.

A planner may encounter frustrating incidents with certain clients in major urban planning projects. For example, in one instance a report submitted by the present inventor included an ‘argument’ for the ‘selection’ of ‘priority’ areas for detailed study. The ‘official’ response to the submission stated in writing that the report did not present sufficient proof for selection of (the inventor's proposal). The statement could be interpreted as asking for proof of one's value judgment. It could be construed alternatively as reflecting only ‘a manner of speech’.

Some clients also ‘indulged’ in using terms such as “bad”, “poor”, and “weak” in commenting on reports submitted by members of the urban planning team. Usually the type of client who ‘indulged’ in ‘denigrating’ the work of the consultant tended to assume certain attitudes. For example, some such clients assumed the position that ‘the consultant is the expert, he should know what is good and what is bad in respect of all facets of his assignment’. The staff on the client's side typically was reluctant to make ‘value judgements’ and to express their ‘preferences’, in order to allow the planning team to ‘assist’ in the formulation of ‘goals’ and ‘objectives’, and to integrate the client's ‘values’ in the planning process. Perhaps they worried that the ‘preferences’ they might express would not correspond with the ‘wishes’ of ‘higher authorities’. At the same time they did not ‘facilitate’ contact with such ‘higher authorities’, nor with the general public. Some officials further believed that ‘the best courses for action can be reached by logical steps and scientific methods’, without the involvement of ‘value judgement’. If the consultant by ‘necessity’ used his ‘value standards’, or those he ‘surmised’ might be the client's ‘values’ in devising courses for action, such clients often tended to ‘reject’ the urban planning team's proposals. When little progress was realized due to their ‘consternation’, they used their ‘power’ over the consultant to get him to expand the parameters to be covered by study and analysis, thinking that the elaboration of the work in this way would lead, by itself, to their ‘elusive’ ends. From a planner's perspective, which considers ‘valuation’ as the ‘driving force’ of action, such clients appear to be avoiding sharing responsibility with the planner/consultant. Tychiformation attempts to secure the involvement of those affected by planning.

Participation of the general public in the planning process will next be considered. When a planner plans his or her own activities, (s)he sometimes seeks the ‘advice’of others. In particular, he may also seek ‘advice’ from family members and close friends who are familiar with his personality. Typically, he expresses his ‘goals’ and seeks ‘assistance’ in how to fulfill them. On the other hand, both on the personal and professional levels, when others seek a planner's ‘advice’ he may try to learn about their ‘needs’ and ‘goals’, in order to be in a position to offer ‘assistance’. The present inventor ‘prefers’ to involve those who seek his ‘assistance’ in the processes of his ‘reasoning’ and to solicit their participation in these processes. It has already been explained how a planner tends to interact with a client who seeks his ‘assistance’ in designing a building. Similar considerations apply to urban planning.

The participation of a single client in the process of designing a building, could be achieved through ‘informal’ verbal discussion in a series of ‘one on one’ sessions. However, this is ‘hardly’ possible in the case of urban planning, where the aim might be to reach and involve the general public. Since the planner is usually unable to meet those involved, in accordance with the principles of the present invention, one attempts to articulate the steps used in the course of the planning process, make the information available to others, and hope to receive ‘feedback’ that allows the planner to provide the required professional ‘assistance’.

The present inventor notes in this context that he consider his desire to promote public participation to ‘predicate’ his adherence to an articulated and ‘detailed’ urban planning process. This was noted above in reference to the quotation: “rational analysis provides a framework to display the decision maker's values and assessments”. Thus, the articulation of the planner's ‘reasoning’ in going through the planning process allows public participation.

The following ‘theoretical preferences’ have been developed in an attempt to involve the general public in accordance with the principles of the invention in the context of the presently described illustrative embodiment. (a) Involve the ‘largest’ number of people that are ‘likely’ to be impacted by the results of a planning assignment, (b) since usually not all can be reached, attempt to involve as many ‘factions’ of the community as can be discerned, and (c) involve the public in the ‘largest’ number of steps in the planning process. Fulfillment of these ‘preferences’ is attempted within ‘practicable’ limits

Direct public participation in the planning process is discussed next. ‘Representation’ could involve ‘distortions’ in conveying the ‘wishes’ of any given community. This is a well-known characteristic of representative systems, either governmental or otherwise. Accordingly, it is preferred in the context of the present invention to query people directly rather than through representatives. The continuing proliferation of personal computers and the possibilities of electronic communication through the Internet are making direct access to the general public progressively more practicable.

A democratic development of consensus is next considered. In urban planning, varying degrees of conflict are encountered. One could encounter several ‘factions’ with opposing ‘interests’, or in some rare cases of ‘smaller’ projects, agreement by most, except for ‘proverbial’ hold-outs who might oppose any scheme for new development or redevelopment.

The present inventor considers the ‘resolution of conflict’ as a central ‘challenge’ to urban planning, often approaching assignments with ‘optimism’, thinking that a ‘clever solution’ could be found that would ‘make everybody happy’, perhaps momentarily even if not ‘for ever’. In practice this rarely happens, if ever. At least, a few individuals all ways remain ‘disgruntled’. It may also be thought that if one is allowed ‘more’ time to conceive a scheme for action, one might be able to satisfy ‘more’ people. In practice however, deadlines for completion of the work are typically specified, and one tends to adhere to them for financial ‘reasons’. The moment usually arrives when decisions are made regarding the selection of a course for action, while those involved are still divided. Under these common circumstances one attempts to develop consensus. The present inventor's ‘preference’ is to try to reach consensus in democratic fashion, and adopt the ‘wishes’ of the majority. In urban planning practice, however, the vote of the ‘powerful’ tends to carry ‘more weight’ than the vote of the ‘weak’. Irrespective, even when consensus is reached democratically, one may still contemplate the notion of ‘the dictatorship of the majority over the minority’. Accordingly, there may be a ‘guarded’ preference for the resolution of conflict democratically.

Consideration of ‘wider’ context is next considered. As in many other fields, context considerations apply in urban planning. The present inventor has found from practical experience that increasing the number of parameters that taken into consideration and expanding the spatial and time contexts covered by study, invariably impact proposals for action. Accordingly, the consideration of ‘wider’ context increases preparedness when presenting the planner's ‘reasoning’ in planning. It increases the planner's ability to answer those who might raise the question ‘did you consider such and such conditions?’

Adoption of the strategic planning approach is next considered. It will be noted the words “within ‘practicable’ limits” are used in conjunction with the ‘preferences’ that cited above. A ‘reason’ for using this phrase is that the resources and time available for planning present constraints that apply to all types of planning, and to the kinds of ‘preferences’ cited. above. Now, limiting the various aspects of context to be covered by study involves the notion of ‘criticality’, and ‘assigning priority to addressing the topmost critical issues within the constraints of available time and resources’. This amounts to a definition of strategic planning. Based on these considerations it appears that strategic planning ‘is a more practicable approach to planning’ than ‘comprehensive’ planning.

In summary, the activities involved in planning different types of activities are similar. However, certain aspects of the activities involved in urban planning are different. One of the main differences is that in urban planning one is likely to be involved with the public at large. Therefore, compared with architecture for example, urban planning which involves more people, potentially involves a ‘larger’ quantum of different ‘value judgements’, and thus more potential for disagreement and conflict. Historically, urban planning may not have been considered in this way. An architect could have conceived the plan of a city largely in intuitive fashion, while working directly with a potentate or other sovereign entity. In contemporary urban planning practice however, the urban planner is usually expected to articulate a ‘planning process’ which allows public ‘debate’, and the formation of consensus. Some lessons gained from the present inventor's experience in following the contemporary version of urban planning can be summarized as follows.

Urban planning generally articulates the ‘reasoning’ processes involved in conceiving ‘solutions’. Adhering to an articulated planning process tends to ‘facilitate’ public ‘debate’, and the formation of consensus. Being a relativist, who ‘prefers not to project his preferences to the outside world’, the present inventor has found that an articulated planning process reinforces his tendency to seek the involvement of the largest number of people in his work. In addition, he has found that adhering to an organized and formalized process of thought, i.e. the planning process, tends to help him remember ‘issues’ that he might have otherwise missed. Accordingly, he tends to adopt an articulated planning process in planning all types of his activities. Generally, he ‘prefers’ to apply the planning process as the framework of his approach to ‘problem’ solving, while allowing an ‘inevitable’ role for intuition.

When applying the planning process, the present inventor ‘prefers’ to apply it in the ‘widest practicable’ context. He ‘prefers’ to cover the ‘greatest’ number of parameters, and expand the context of study both spatially, and in past and future time, within ‘practicable’ limits. Generally, he has found that he develops ‘greater confidence’ in planning efforts through widening the context of the scope of the parameters, the spatial expanse, and the duration of time covered by study. However, the present inventor's ‘preference’ to expand the context that covered in his planning efforts is usually ‘constrained’ by considerations of ‘practicability’. This leads to adoption of a strategic approach in planning that contemplates ‘criticality’ and ‘prioritization’ of efforts, allowing containment of efforts within ‘the constraints of time and resources’ that may be available for a given planning exercise. In addition to the foregoing, there are many areas involving population problems, economic and social problems, climatic events and changes, geography, public works projects, and so forth where a consensus approach in accordance with the principles of the present invention offers useful and interesting possibilities for recognizing problem areas and issues that merit attention and for arriving at an acceptable resolution and in certain cases, appropriate solutions.

Conception of the Notion of Tychiformation is next discussed. Concepts considered in the foregoing discussion include (a) expansion of the application of planning to areas where traditionally, it has not been ‘utilized’, and (b) addressing the topics contemplated may be considered as an attempt towards the organization of ‘civic society’ through a planning process. At this point, no definition is introduced that defines an attempt to address ‘morality’ in systematic fashion that contemplates the interactive participation of the general public as a “planning activity”. Accordingly, the word “planning” no longer coveres the widened scope contemplated herein for ‘planning’. Rather, the suggestion is that action is contemplated to shape the future, rather than undertaking action to plan for the future.

From the Greek words “tychi” for “future”, and “forma” for “shape”, the present inventor has conceived and coined “tychiformation” as a word that would incorporate the kinds of proposals for action herein contemplated in accordance with the present invention. Tychiformation may be pronounced as though it were spelled ‘tikey-formation’.

In a sense, humans are, have been, and will continue to shape the future by their collective action. When a person ‘wastes’ paper, water, or energy, his or her action would have implications on the environment, and thus on shaping the future of the earth and humanity. Whether one has two or ten children also would impact environmental conditions and the future of humanity, since population growth is ‘likely’ to lead to ‘negative’ impacts on the environment. People may not always be consciously aware of the implications of their action. The implications of ‘wasting’ natural resources, and of population growth on environmental conditions however, are being systematically understood and documented. Governments also shape the future by their action, although they may not all ways involve the general public in decision making. Tychiformation by contrast, proposes a conscious and ‘willful’ approach to shaping the future that ‘predicates’ the direct democratic involvement of ‘as many people as possible’ in a systematic process to shape the future.

Accordingly, tychiformation is not ‘intended’ to be pursued by any one individual alone. Now, to adhere consistently to the understanding of an aspect of tychiformation as herein set forth, one could stop writing at this juncture, and start to poll others about how to proceed with tychiformation.

Polling others regarding tychiformation one possible goal in setting forth the present disclosure. However, in reaching this aim, one may still continue to further explore the potential for tychiformation. The following is therefore not to be construed as an individual's attempt to shape the future but rather, an attempt to illustrate how tychiformation could possibly proceed.

A possible definition of tychiformation is as “an attempt to control, or shape the future of humanity through application of a systematic planning process”. Furthermore, it is contemplated that the planning process describe above, together with the ‘preferences’ regarding planning heretofore expressed, embody the systematic approach of tychiformation. Accordingly, tychiformation would attempt to adhere to the articulated steps of a planning process, cover the ‘widest’ context, and directly and democratically involve the ‘largest’ number of people in strategic fashion within ‘practicable limits’.

Alternative aspects of Tychiformation are considered next. Tychiformation, like urban planning could be approached in different ways. There were described above some of the common approaches to urban planning, such as the top down, bottom up, reactive, proactive, strategic, and comprehensive approaches. It is herein recognized that such approaches could be tested in the pursuit of tychiformation, with a possible exception. From practical experience it appears that one might be able to plan for the construction of a building in ‘relatively comprehensive fashion’. However, planning for action with respect to every nook and cranny of a town or city presents some difficulty. Accordingly, as indicated, ‘comprehensive’ urban planning may not be a practicable option. It is contemplated that tychiformation can involve ‘several’ orders of magnitude of complexity compared with urban planning. Therefore, a ‘comprehensive’ approach to tychiformation appears to be conceptually difficult.

As to the initiation of Tychiformation in the context of the present exemplary embodiments, the urban planning process is usually approached according to the steps indicated above. It usually starts with the activity of gathering data or information about existing and past conditions, and proceeds to cover the steps indicated. However, as was mentioned, the process is iterative, and ‘need not necessarily’ be followed in rigid sequence. The urban planning process is often initiated when an ‘issue’ has been identified, or when a ‘goal’ has been stated. It is herein contemplated that, in certain applications, tychiformation be initiated by polling people about ‘issues’ and ‘goals’, rather than by collecting other types of information. By this is meant that tychiformation would be initiated by gathering particular information regarding ‘valuation’ from the general public, rather than by gathering descriptive data about past and present socioeconomic and physical conditions, in addition to information that is available at present. The collection of additional information to what is available would proceed ‘in light of’ the expressed ‘issues’ and ‘goals’.

Strategic ‘Top Down’ Tychiformation is a potential approach that is preferred as embodying preferred concepts regarding ‘criticality’, and thus is expressive of a preferred position regarding ‘prioritization’ and a strategic approach to Tychiformation. The approach would consider initiation of tychiformation through articulation of particular ‘goals’, rather than through compilation of lists of ‘issues’ to be addressed.

For example, based on observation, survival may be considered to be ‘most critical’; thus, addressing survival as a matter of ‘priority’ would be ‘in line’ with a strategic approach to tychiformation and probably the ‘goal’ of self-preservation ‘holds promise for wide acceptance’, and thus, it could provide a ‘relatively solid base to build on’. The definition of ‘goals’ envisioned in this approach could conceivably proceed in pyramidal fashion.

By way of further example, numerous ‘goals’ could be considered as ‘closely related’ to survival. For example, a set of ‘goals’ would relate to ‘satisfying’ ‘needs’ for food, medical care, and so on. Others would involve ‘satisfying’ an instinctive drive for “self propagation”.

‘Satisfying’ most ‘goals’ for survival would involve numerous other humans. Other ‘goals’ that could follow those relating to securing existence might concern ‘well-being as a person continues to exist. Contemplating both sets of ‘goals’ for ‘securing my existence and personal well-being leads to consideration of one's ‘reliance’ on, and ‘need’ for other humans. Accordingly, one could move from the ‘goal’ of self-preservation, to the ‘goal’ of securing the survival of the human species, or at least, securing the survival of ‘a number’ of other humans that ‘one would require in order to secure one's own survival and well being’. It would appear that the move from the ‘goal’ of self-preservation to the ‘goal’ of the survival of at least a ‘number’ of other humans could be spanned by a ‘large majority’ of humans.

The consideration of the ‘goal’ of the survival of some, could expand to consideration of the survival of ‘the fittest’, the survival of all humans, and further to unborn ‘humans’ or fetuses. Another possible expansion of the consideration of the ‘goals’ relating to survival and to ‘well being’ could relate to the survival of living entities in general. This could proceed to consideration of ‘goals’ to secure the survival of all life forms; i.e. animals, insects, plants, and microorganism, and even pathogens, since the latter are part of the ecosystem of life.

Another set of ‘goals’ relating to survival could be probed through consideration of potential threats to survival; that is, threats to the survival of humans, as well as life in general as it is known on earth. This topic may well be of ‘topmost critical and strategic importance’.

For example, current cosmological theory proposes the ‘hypothesis’ of a ‘big bang’ or explosion, as the incident of origination of the universe. Cosmologists are currently debating whether the universe will continue to expand as a result of the ‘big bang’, or whether the force of gravity will eventually bring the universe to an implosion, or a ‘big crunch’. Either of the two alternatives would threaten the survival of humans and all forms of life that we know. A ‘big crunch’ on the other hand would mean the annihilation of ‘everything’. When one considers the survival of humanity in such an expanded time parameter, one comes to the realization of a ‘problem’ that one does not know how to cope with.

Within our own galaxy and solar system, scientist tell us that our star, the sun, is ‘likely’ to get bloated to a ‘red giant’ that would engulf earth and all other planets. A ‘goal’ in this context could be formulated to “prepare to abandon earth”, and a related objective could state: “develop technologies for interstellar travel by the year ‘y’ billion.”

In the mean time, i.e. until such ‘catastrophic’ cosmic events take place, one might surmise that we may continue to ‘enjoy’ living on earth; however, scientists have warned about the potential bombardment of the earth by meteors and comments that could potentially ‘wreak havoc on earth’, as may have happened in the past, leading to the extinction of the dinosaurs. ‘Goals’ and ‘objectives’ in this respect could relate to developing strategies and technologies to divert the trajectories of such objects in order to avoid catastrophic damage to the earth, or possibly, its total destruction.

Other threats to the existence of humans and life on earth relate the physical composition and dynamic nature of earth itself. The movement of tectonic plates leading to earthquakes and volcanic eruptions illustrate some of the perils to existence related to the dynamic nature of earth. Science is striving to understand the dynamic earth, and ‘goals’ and ‘objectives’ could be possibly formulated to address related ‘issues’.

In general, threats to our existence and survival come from different sources ranging from cosmological factors down to microscopic agents such as viruses. Tychiformation would be concerned with a systematic listing of such threats, and with attempts to address related ‘issues’ in strategic fashion.

Furthermore, threats to the existence of humans and life in general, could be related to the action of humans. One type of threat relates to the action of humans on the environment through pollution, and the modification of ecosystems, which could lead to the extinction of life on earth. ‘Goals’ and ‘objectives’ are being formulated in this respect. Some relate to ‘issues’, such as global warming and the reduction of the use of fossil fuels, and some could relate to the containment of population growth. It is contemplated that tychiformation can be applied to augment efforts to address environmental ‘issues’, and to increase public participation in addressing these issues.

Another type of threat to the existence of humans relates to the action of humans upon other humans. The threat comes from crime, by one human killing another for some ‘reason’. The threat to humans from other humans comes often as a result of conflicts and wars, usually between different ethnic, religious, and ideological ‘factions’ of humans. History provides an account of such conflicts, and of the associated casualties.

Consideration of the threat to the survival of the individual human by other humans, could be expanded to cover the threat to the individual's well-being through the action of others, such as through ‘exploitation’, for example. All such types of threat to humans through other humans, whether relating to existence or to ‘well being’, would involve consideration of ‘moral issues’. Accordingly, it is contemplated that an inquiry into ‘moral’ or ‘ethical norms of conduct’ be pursued through tychiformation.

Addressing ‘moral issues’ can be pursued by polling people about their ‘expectations’in their interactions with other humans. In other words individuals could be polled about the ‘goals’ they wish to achieve in respect of their relations with other humans. From an individual perspective, one can contemplate a ‘wish’ list such as that others would not kill one, would offer one ‘help’ when needed, be ‘courteous’ and ‘fair’ rather than ‘aggressive’ and ‘unfair’ in their dealings with one, and so on. One can contemplate polling people in this context about the definition of “fairness” and “unfairness” for example. People can be polled also about whether, or not, they are willing “to do unto others, what they hope others would do unto them”.

An ‘issue’ relating to democracy can be raised. In particular, a concern regarding ‘the dictatorship of the majority’ can be raised. People could be reminded that ‘invariably they are bound to find themselves as part of a minority with respect to some of their views’. In such cases, would they be willing to accept and abide by ‘the majority's will’, even if they ‘strongly’ disagree with the majority's decision? Polling people in these ways would provide ‘quantitative’ information about people's ‘feelings’, and could ‘influence’ decisions regarding legislation on matters presently controversial, such as abortion, for example. Ultimately, perhaps, a systematic tychiformist approach to the definition of ‘moral norms’ might lead to ‘more tolerance’ and ‘a more liberal organization of civic society’.

From the foregoing discussion, one may come to a conclusion that a strategic approach to tychiformation could be pursued along three ‘main’ lines involving consideration of ‘goals’, ‘objectives’, ‘issues’, ‘opportunities’ and ‘constraints’, and alternative courses for action relating to: a) survival of the individual and the human species, b) ‘moral’ or ‘ethical’ conduct, and c) the ‘well being’ or the ‘quality of life’ of the individual,. An individual may reason that:

1. I wish to survive

2. Contemplating the ‘fulfillment’ of my ‘goal’ to survive, leads me to realize my ‘need’ for other humans

3. The existence of other humans however, could potentially lead to ‘conflicts’ among us

4. I wish to devise ‘moral’ or ‘ethical norms of conduct’ that would ‘facilitate’ my coexistence with other humans

5. I wish to prolong my life ‘as much as possible’, and to maintain a certain ‘quality of life’ as I continue to exist

6. Contemplating the ‘fulfillment’ of my ‘goals’ regarding the ‘quality of my life’, confirms my ‘need’ for other humans

7. Consideration of 1 to 6 above confirms my wish to devise ‘moral norms of conduct’ to ‘facilitate’ my coexistence with other humans.

This progression of statements may not be a novel revelation in itself. We would not have religions, or the various types of organization of civic societies that exist in the world today if human ancestors did not think in ways similar to the above. Tychiformation would attempt to continue and augment such efforts to organize civic society and to shape the future of humanity, albeit in a ‘more’ systematic fashion that involves the direct participation of the general public.

In comparison with Bottom-up Tychiformation, it may be said that a top down approach to tychiformation could lead to an exponential expansion of the ‘goals’, ‘objectives’, ‘issues’, etc. that would be presented to the general public for consideration. Polling people about ‘criticality’ and ‘priorities’ would be pursued in an effort to match tychiformation efforts to ‘available resources’. Irrespective however, tychiformation could proceed in bottom up fashion, i.e., by addressing particular topics of ‘interest’. As in urban planning, tychiformation efforts ‘need’ not be halted awaiting the results of a top down approach. All types of topics relating to the organization of civic society for example could be addressed independently in parallel with the top down approach that outlined above. ‘Issues’ relating to economic theory and practice can be pursued independently. Although ‘ethical’ considerations that could be derived from a top down approach would be involved in such kinds of exercise, bottom up tychiformation could still be attempted. Assumptions, such as “equal compensation for equal output” could be proposed for adoption in a bottom up tychiformist approach to addressing economic ‘issues’, pending ‘resolution’ of this ‘ethical issue’ from a top down approach. That is to say, people could be polled regarding the ‘acceptability’ of the notion of equal pay for productivity whether by a female or a male, a black, red, yellow, or white person for example, ‘without necessarily having resolved all moral issues in top down fashion’. All types of ‘issues’ could be addressed and pursued in similar bottom up fashion.

Next, considerations of Reactive/Proactive Tychiformation are considered. Tychiformation, like urban planning, is ‘likely’ to involve both reactive and proactive attitudes. The reactive attitude would be reflected in the acceptance of prevailing conditions and trends, while the proactive attitude would be reflected in a willingness to modify and change conditions. The mixture of the extent of the proactive and reactive attitudes to tychiformation would materialize in the results of polling the public regarding each particular topic under consideration. Generally an evolutionary approach appears preferrable rather than a revolutionary approach.

The extent to which tychiformation can be implemented relates to the number of people who elect to ‘believe’ in a tychiformist approach, and to the extent of the ‘resources’ that would be committed to the pursuit of tychiformation. If tychiformation takes off at all, it can first be pursued as a ‘limited’ experiment or pilot project to test the ‘viability’ and ‘practicability’ of tychiformation. Several experiments with tychiformation can be pursued in parallel. Alternatively, tychiformation can be accorded resources matching, for example, the Human Genome Project. Consideration of such a potentiality leads one to recognize a ‘practical constraint’ to tychiformation. The Human Genome Project involves a large number of scientists working in their labs. A Tychiformation Project of similar magnitude could involve a ‘large’ number of scientists as well as ‘experts’ from various disciplines. However, compared with the Genome Project, a Tychiformation Project would attempt to involve the general public, in addition to ‘experts’. The question arises as to how much time people would dedicate to responding to tychiformation queries. This question may be answered by a practical trial. People visit the World Wide Web (www) for a few minutes a day to register their vote on tychiformation ‘issues’. Interactive television will enable a person to watch the news, for example, and use his remote control to register his vote on tychiformation ‘issues’ that would be presented for a few minutes after the news broadcast. The extent of people's ‘interest’ would ultimately influence the pace of tychiformation.

It is preferred that tychiformation be pursued internationally, in an attempt to involve and allow the integration of the myriad of different ideas and attitudes of as many ‘factions’ of people, and as many ‘cultures’ as ‘practicable’. The availability of computers and the possibility of reaching the general public would vary in different countries. Possible sponsorship by the United Nations could be desirable to that end. Since not all can reached, statistical sampling techniques can be used in a tychiformation effort in an analogous manner to present usage of such techniques in current polling efforts.

Preferrably, tychiformation to be conducted by independent entities. On the one hand, new ‘independent’ institutions for tychiformation can be established. ‘Patrons’, such as computer and software companies may interest in promoting tychiformation, and in providing funding for tychiformation efforts. Universities are good candidates for conducting tychiformation efforts for at leasst two reasons: (a) universities are ‘presumably independent’ of ‘political influence’, and (b) universities usually comprise faculties that could provide the different types of ‘experts’ in the fields that would be involved in tychiformation.

Tychiformation can start by polling the ‘largest’ number of people that can be reached through the www, for example, and attempting to involve them in the definition of ‘issues’ to be addressed. A list of ‘issues’ is then compiled. Those polled could be queried regarding the ‘criticality’ or ‘priority’ of ‘issues’ to be addressed. Alternatively, they can be at once queried to list their ‘grievances in order of priority’. The steps of a systematic planning process would be then pursued in view of reaching conclusions regarding the ‘topmost priority issues’ within ‘practicable limits’.

Tychiformation would proceed by involving those who could be reached in ‘as many’ steps of tychiformation ‘as practicable’. Those who could be reached would be involved for example in the conception of alternative scenarios for action, the ‘evaluation’ of alternatives, and so on. Their involvement would be pursued until a ‘consensus’ for action is reached democratically with respect to each ‘priority issue’ that had been selected for ‘resolution’. All of this would be pursued within ‘practicable limits’.

The results of tychiformation efforts and queries would ‘influence’ politicians and Governments in a way similar to that of present polling surveys. The difference of the potential ‘influence’ between present polling approaches and those involved with tychiformation would relate to the systematic nature, and to the expanded subject matter of tychiformation.

It is contemplated that in the context of the present invention, a strategic approach to tychiformation would start with topics regarding survival, and would proceed to topics regarding ‘moral issues’, and further to the consideration of the ‘quality of life’ of the individual human. One reason for suggesting this order relates to a ‘subjective assessment of criticality’, and moreover, to an expectation that ‘greater’ degrees of agreement might be attained in considering categories of topics in this order. This expectation would be confirmed or negated based on actual polling of the general public.

It is contemplated that the present invention will be implemented using most conveniently a programmable digital computer system.

While the invention has been described by way of exemplary embodiments, it will be understood that this is by way of example only and that the invention itself has wider application and is not limited to such exemplary embodiments which are herein used for convenience and ease of explanation of the principles of the invention. Furthermore, it will be understood by one of skill in the art to which it pertains that various changes and modifications made be made to described embodiments without departing from the spirit of the invention in which the claims following should be construed.

What is claimed is:

1. A method for interactive communication, comprising the steps of: gathering information about a topic;
analyzing said information to identify existing and potential issues; selecting ones of said issues in accordance with selection criteria to form a set of selected issues;
formulating goals in respect of said selected issues; preparing alternative scenarios for resolving said selected issues for meeting said goals; evaluating said alternative scenarios; and
selecting at least one of said scenarios for meeting said goals.

2. A method for interactive communication in accordance with claim 1 including a step of determining said selection criteria.

3. A method for interactive communication in accordance with claim 2, wherein said step of determining said selection criteria includes a step of interactively utilizing participation with others to carry out said determining.

4. A method for interactive communication in accordance with claim 1, wherein said step of analyzing said information includes a step of interactively utilizing participation with others to carry out said analyzing.

5. A method for interactive communication in accordance with claim 1, wherein said step of selecting ones of said issues includes a step of interactively utilizing participation with others to carry out said selecting.

6. A method for interactive communication in accordance with claim 2, including a step of determining said given selection criteria utilizing participation with others to carry out said selecting.

7. A method for interactive communication in accordance with claim 1, wherein said step of formulating goals includes a step of interactively utilizing participation with others to carry out said formulating.

8. A method for interactive communication in accordance with claim 1, wherein said steps of preparing alternative scenarios and of evaluating said alternative scenarios includes respective steps of interactively utilizing participation with others to carry out said preparing and eveluating.

9. A method for interactive communication in accordance with claim 1, wherein said step of selecting at least one of said scenarios for meeting said goals includes a step of interactively utilizing participation with others to carry out said selecting.

10. A method for interactive communication, comprising the steps of:
selecting a topic
gathering information about said topic;
analyzing said information to identify existing and potential issues;
selecting ones of said issues in accordance with given selection criteria to form a set of selected issues;
formulating goals in respect of said selected issues;
preparing alternative scenarios for resolving said selected issues for meeting said goals;
evaluating said alternative scenarios;
selecting at least one of said scenarios for meeting said goals; and
including a respective step of participation with others in any of the foregoing steps.

11. A method for interactive communication as recited in claim 10, wherein said respective steps of participation with others includes public participation.

12. A method for interactive communication as recited in claim 11, wherein said respective steps of public participation include interactive public participation.

13. A method for interactive communication as recited in claim 12, wherein said respective steps of public participation include direct interactive public participation.

14. A method for interactive communication as recited in claim 11, wherein said respective steps of public participation include a step of communication by utilizing the World Wide Web or Internet.

15. A method for influencing a course of events in a topic, comprising the steps of:
selecting said topic, including exchanging information interactively with others;
gathering information about said topic, including exchanging information interactively with others;
analyzing said information to identify existing and potential issues, including exchanging information interactively with others concerning said analyzing;
selecting ones of said issues in accordance with selection criteria to form a set of selected issues, including exchanging information interactively with others concerning said selecting and said selection criteria;
formulating goals in respect of said selected issues including exchanging information interactively with members others concerning said formulating goals;
preparing alternative scenarios for resolving said selected issues for meeting said goals including exchanging information interactively with others concerning said preparing alternative scenarios;
evaluating said alternative scenarios, including exchanging information interactively with others concerning said evaluating; and
selecting at least one of said scenarios for meeting said goals, including exchanging information interactively with others concerning said selecting.

16. A method for influencing a course of events as recited in claim 15, wherein said exchanging information interactively with others includes public participation.

17. A method for influencing a course of events as recited in claim 16, wherein said public participation includes a step of communication by utilizing the World Wide Web or Internet.

18. A method for influencing a course of events as recited in claim 15, wherein said steps of said method are performed utilizing a programmable digital computer.
